(19) United States
(12) Patent Application Publication
(10) Pub. No.: US 2012/0002412 A1
(43) Pub. Date: Jan. 5, 2012

(54) Light Source Device

(76) Inventor: Shih-Chieh Cheng, Taoyuan City (TW)

(21) Appl. No.: 12/830,215

(22) Filed: Jul. 2, 2010

(51) Int. Cl. F21V 1/00

(52) U.S. Cl. 362/235

(57) ABSTRACT

A light source device comprises at least two reflecting members and light sources corresponding to each other. The reflecting member has a top surface and an arc bottom surface, and a reflecting curved surface extended toward the top surface from the arc bottom surface. The arc bottom surface forms a containing space for placing the light source. A light outgoing surface of the arc bottom surface is toward the top surface. The reflecting curved surface of each reflecting member is disposed by corresponding to each other. Accordingly, a light beam of each light source can achieve the effect of illuminating in a wide-angle through the reflection of each reflecting member, and the luminous flux can be uniformly distributed within a unit area.

### BACKGROUND OF THE INVENTION

1. Field of the Invention

The present invention relates to a light source device, and more particularly to a light source device capable of achieving the effect of illuminating in a wide-angle and having more uniform luminous flux distribution within a unit area.

2. Description of the Related Art

In recent years, since the luminescence efficiency of a LED (light emitting diode) has increased 100 times and the cost decreased 10 times, the future development of LED attracts global illumination companies to invest much money and resources in LED light source business and markets thereof. Currently, energy may be consumed in a large number since economy is quickly developed. Electric power consumed by illumination occupies one six in total consumption. Therefore, increasing the efficiency of illumination products will decrease energy consumption largely and effectively relieve the tension of environmental protection. “LED illumination” has been listed as an important development and a priority for energy saving. The illumination engineering for green energy saving is greatly pushed, and LED road lamps are an important energy saving application in LED illumination technology.

A road illumination design must consider the illumination efficiency, the service life, the economy, and the adaptability for local weather conditions and regulates and selects the optimum light beam distribution based upon the wide or narrow of actual road surfaces so that the illuminated areas can be averagely distributed. The phenomenon, such as the dark or the harsh light, may not be produced to influence the sight of drivers. Alternatively, the luminous flux F of lamps, the distance between lamps and the height must be decided according to the illumination body and the illumination intensity requirement, thereby bringing the optimum illumination efficacy of lamps into full play. The luminous flux F is a total energy for a light emitted by a light source in unit time by taking all light beams and called total fluxes, wherein the unit is lumen, lm, and the definition is that a unit of luminous flux equals to the amount of light given out through a solid angle of 1 steradian by a point source of 1 candela intensity radiating uniformly in all directions.

With reference to FIG. 1 for a light source distribution is formed by a single LED in which the emission angle is 120 degrees. As shown in the figure, the irradiation angle of the LED's distribution is bigger, and the light intensity is concentrated at a range in which the light source vertically and downwardly irradiates. However, since the LED road lamps 1 are spaced at intervals and arranged on the road surface 2. Moreover, the LEDs 11 have the feature of linearly projecting lamp-light by nature. Consequently, the luminous flux F of the LED road lamps is almost projected on the central areas 21. Further, the illumination intensity E is inversely proportional to the square of distance R through the calculation formula of the illumination intensity E. Since the luminous flux F of side areas 22 is insufficient, the illumination intensity of the side areas 22 is lower than the illumination intensity of the central areas 21.

The brightness of the central areas 21 is obviously different from the brightness of the side areas 22. While driving vehicles, drivers may be influenced by flare generated by rapidly varying lamp lights, resulting in the discomfort in the sight

In addition, the luminous flux of the LED road lamps 1 is not effectively projected on different areas of the road surface 2. The most luminous flux is concentrated on the central areas 21. The central areas 21 are brighter than the side areas 22. The use efficiency of luminous energy of the LED road lamps is poor.

### SUMMARY OF THE INVENTION

In view of the shortcomings of the prior art, the inventor of the present invention based on years of experience in the related industry to conduct extensive researches and experiments, and finally developed a light source device that is applied to a road lamp or other illumination devices to achieve the effect of illuminating in a wide-angle and to have more uniform luminous flux distribution within a unit area.

Therefore, it is a primary objective of the present invention to overcome the aforementioned shortcoming and deficiency of the prior art by providing a light source device.

To achieve the foregoing objective, the light source device of the present invention comprises at least two reflecting members and two light sources corresponding to each other. The reflecting member has a top surface and an arc bottom surface, and a reflecting curved surface extended toward the top surface from the arc bottom surface. The arc bottom surface forms a containing space for placing the light source. A light outgoing surface of the light source is toward the top surface, and the reflecting curved surface of each reflecting member is disposed by corresponding to each other. Accordingly, a light beam of each light source can achieve the effect of illuminating in a wide-angle through the reflection of each reflecting member, and the luminous flux can be uniformly distributed within a unit area.

### BRIEF DESCRIPTION OF THE DRAWINGS

FIG. 1 is a distribution diagram of a light source formed by a single LED (light emitting diode);

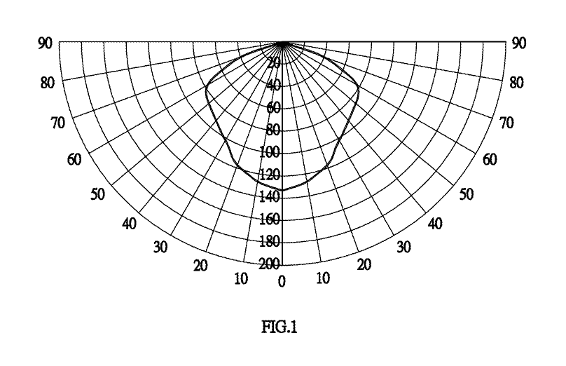

FIG. 2 is a plane diagram of a road surface illuminated by conventional road lamps;

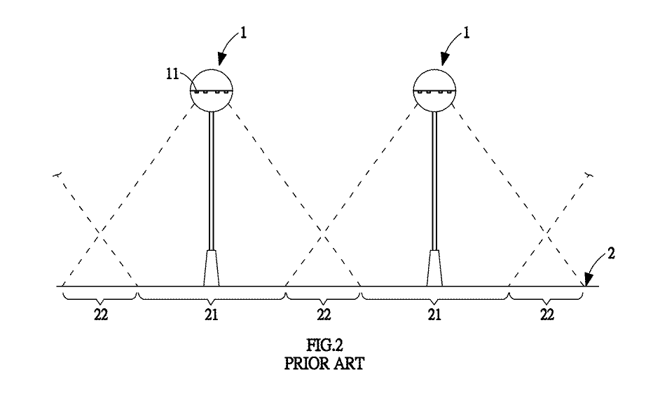

FIG. 3 is a three-dimensional diagram of a structure of light source device according to a first embodiment of the present invention;

FIG. 4 is a schematic diagram of another structure of light source device according to a first embodiment of the present invention;

FIG. 5 is a schematic diagram of a light beam of a light source device according to a first embodiment of the present invention;

FIG. 6 is a distribution diagram of a light source device according to a first embodiment of the present invention;

FIG. 7 is a schematic diagram of another light beam of a light source device according to a first embodiment of the present invention;

FIG. 8 is a three-dimensional diagram of a structure of a light source device according to a second embodiment of the present invention;

FIG. 9 is a schematic diagram of a structure of light source device according to a second embodiment of the present invention;

FIG. 10 is a distribution diagram of a light source device according to a second embodiment of the present invention;

FIG. 11 is three-dimensional diagram of a structure of a light source device according to a third embodiment of the present invention;

FIG. 12 is a schematic diagram of a structure of light source device according to a third embodiment of the present invention;

FIG. 13 is a distribution diagram of a light source device according to a third embodiment of the present invention;

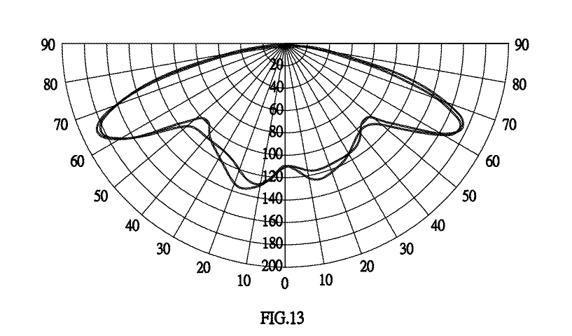

FIG. 14 is a schematic diagram of a light source device disposed to a road lamp according to the present invention; and

FIG. 15 is a plane diagram of a road surface illuminated by road lamps according to the present invention.

### DETAILED DESCRIPTION OF THE PREFERRED EMBODIMENTS

The foregoing and other technical characteristics of the present invention will become apparent with the detailed description of the preferred embodiments and the illustration of the related drawings.

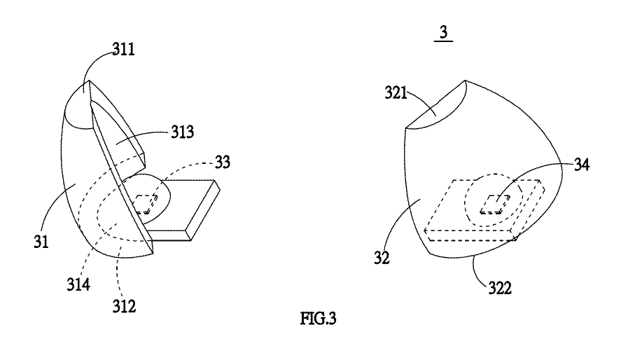

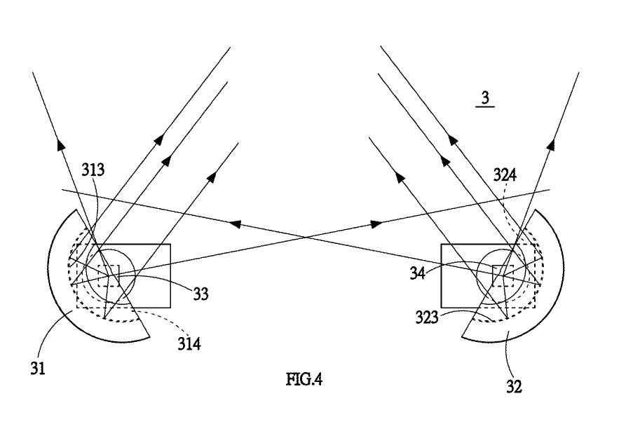

With reference to FIG. 3 to FIG. 4 for a light source device in accordance with a first embodiment of the present invention, the light source device 3 comprises at least two reflecting members and a first light source 33 and a second light source 34 at least. As shown in the embodiment, a first reflecting member 31 and a second reflecting member 32. The first reflecting member 31 and the second reflecting member 32 have top surfaces 311,321 and arc bottom surfaces 312, 322 and reflecting curved surfaces 313, 323 extended toward the top surfaces 311, 321 from the arc bottom surfaces 312, 322. The arc bottom surfaces 312, 322 form containing spaces 314, 324 for placing the light sources. Reflecting curved surfaces 313, 323 of reflecting members 31, 32 are disposed by corresponding to each other. The first reflecting member and the second reflecting member slightly incline toward fronts.

The light sources 33, 34 correspond to the reflecting members 31, 32. The first light source 33 and the second light source 34 are respectively placed in the containing spaces 314, 324, and light outgoing surfaces of the light sources 33, 34 are toward the top surfaces 311, 321.

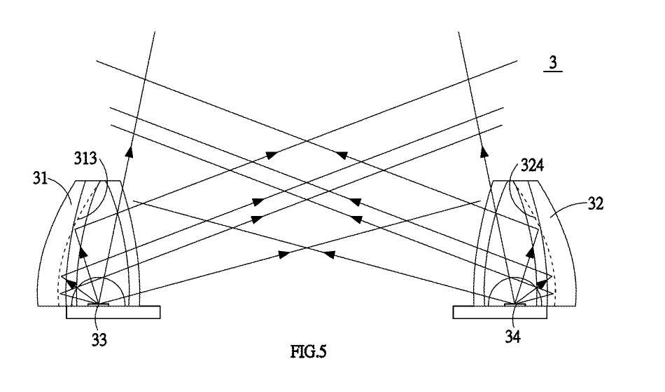

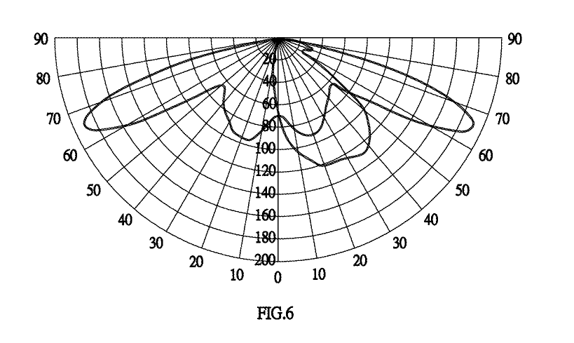

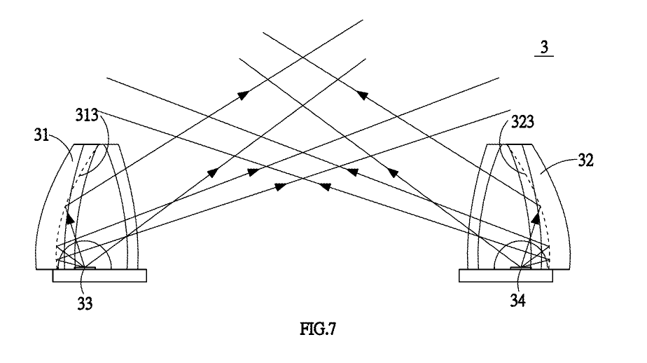

As shown in FIG. 4 and FIG. 5, the first light source 33 and the second light source 34 can be disposed to focal points of the reflecting curved surfaces 313, 323. A portion of light beams of the first light source 33 and the second light source 34 form parallel light beams and can be irradiated toward the fronts through the reflection of the reflecting curved surfaces 313, 323. The light source distribution of the light sources 33, 34, as shown in FIG. 6, can have the irradiation range in wide-angle and increase the uniformity for light beam distribution. Alternatively, the first light source 33 and the second light source 34 can be disposed to places that are distant from the focal points of the reflecting curved surfaces 313, 323. As shown in FIG. 7, non-parallel light beams are formed and irradiated toward the fronts.

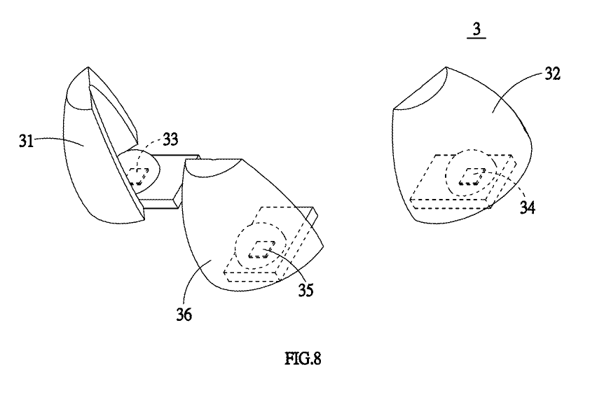

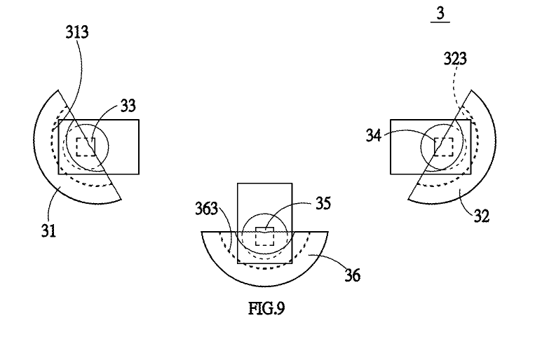

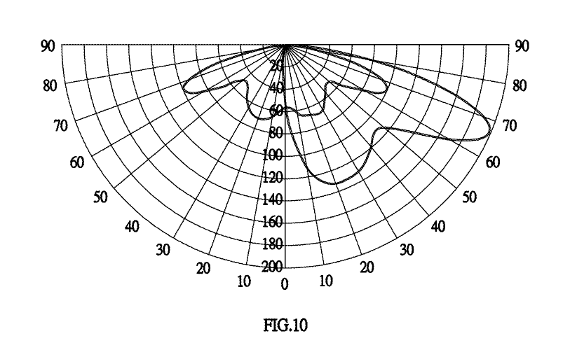

As shown in a second embodiment of FIG. 8 and FIG. 9, the light source device is further equipped with a third light source 35 and a third reflecting member 36. The third reflecting member 36 is disposed between the first reflecting member 31 and the second reflecting member 32 and not overlapped a region in which two reflecting curved surfaces 313, 323 correspond to each other. A reflecting curved surface 363 of the third reflecting member 36 is disposed toward a front. The light source distribution of the light sources 33, 34, 35, as shown in FIG. 10, can have the irradiation range in wide-angle and increase the uniformity for light beam distribution.

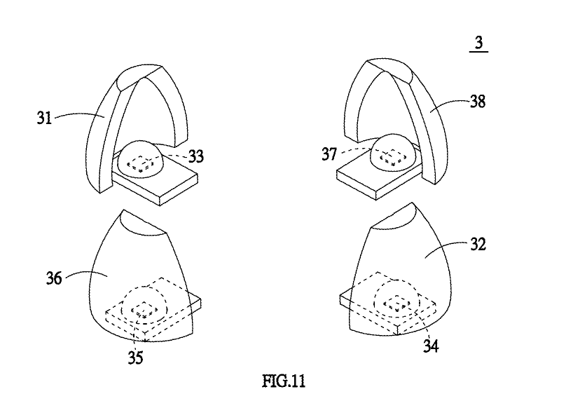

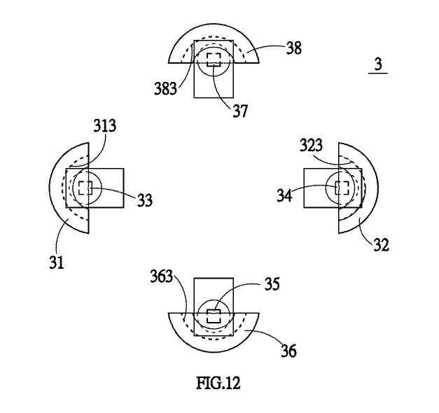

As shown in a third embodiment of FIG. 11 and FIG. 12, the light source device has a first light source 33, a second light source 34, a third light source 35 and a fourth light source 37 and a first reflecting member 31, a second reflecting member 32, a third reflecting member 36 and a fourth reflecting member 38 corresponding to each other. The reflecting curved surfaces 313, 323 of the first reflecting member and the second reflecting member correspond to each other. Reflecting curved surfaces 363, 383 of the third reflecting member and the fourth reflecting member correspond to each other. The light source distribution formed by the light sources 33, 34, 35, 37, as shown in FIG.

13, can have the irradiation range in wide-angle and increase the uniformity for light beam distribution.

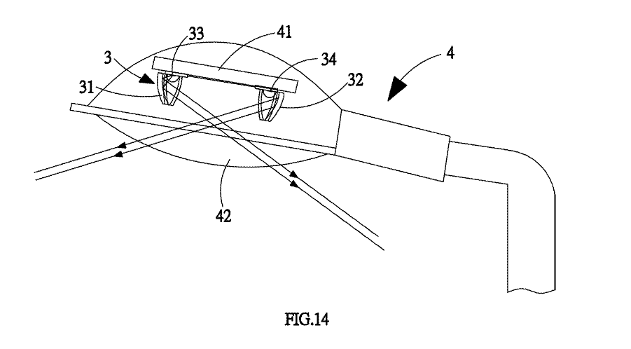

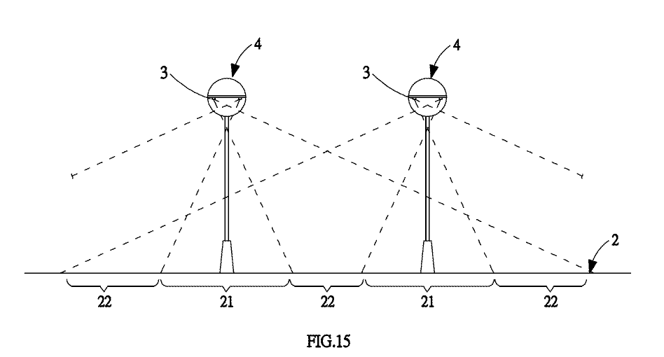

The light source device of the foregoing embodiments can be installed in a road lamp. As shown in FIG. 14, the road lamp 4 has a bottom seat 41 and a light-transmissive housing 42. The light source device 3 is mounted to the bottom seat 41. Light beams emitted by the light sources 33, 34 can pass through the light-transmissive housing 42 through the reflection of the reflecting members 31, 32. When the road lamps 4 are installed on a road surface 2, as shown in FIG. 15, a portion of light beams that are vertically projected on central areas 21 of the road surface can be irradiated toward side areas 22 through the reflection of the reflecting members, thereby compensating the luminous flux of the side areas 22. Accordingly, the luminous flux can be uniformly distributed within a unit area. In another word, identical illumination intensity for the side areas 22 and the central areas 21 can be generated without producing different light beam brightness. Drivers may further acquire comfort in sight all the way while driving vehicles.

The present invention improves over the prior art and complies with patent application requirements, and thus is duly filed for patent application. While the invention has been described by device of specific embodiments, numerous modifications and variations could be made thereto by those generally skilled in the art without departing from the scope and spirit of the invention set forth in the claims.

What is claimed is:

1. A light source device comprising:
at least two reflecting members, the reflecting member having a top surface and an arc bottom surface, and a reflecting curved surface extended toward the top surface from the arc bottom surface, the arc bottom surface forming a containing space for placing a light source, wherein the reflecting curved surface of each reflecting member is disposed by corresponding to each other;
at least two light sources, each light source corresponding to each reflecting member, the light sources are placed in the containing spaces, wherein a light outgoing surface of the light source is toward the top surface.

2. The light source device as recited in claim 1, wherein the light source device is equipped with a first light source and a second light source and a first reflecting member and a second reflecting member corresponding to the first light source and the second light source.

3. The light source device as recited in claim 2, wherein the first reflecting member and the second reflecting member slightly incline toward a front.

4. The light source device as recited in claim 2, wherein the light source device is disposed in a road lamp, and the road lamp has a bottom seat and a light-transmissive housing, and the light source device is disposed on the bottom seat, and a light beam of each light source is reflected by each reflecting member and passes through the light-transmissive housing.

5. The light source device as recited in claim 3, wherein the light source device is further equipped with a third light source and a third reflecting member, and the third reflecting member is disposed between the first reflecting member and the second reflecting member and not overlapped a region in which two reflecting curved surfaces correspond to each other, and the a reflecting curved surface of the third reflecting member is disposed toward a front.

6. The light source device as recited in claim 5, wherein the light source device is disposed in a road lamp, and the road lamp has a bottom seat and a light-transmissive housing, and the light source device is disposed on the bottom seat, and a light beam of each light source is reflected by each reflecting member and passes through the light-transmissive housing.

7. The light source device as recited in claim 1, wherein the light source device is equipped with a first light source, a second light source, a third light source and a fourth light source and a first reflecting member, a second reflecting member, a third reflecting member and a third reflecting member, and reflecting curved surfaces of the first reflecting member and the second reflecting member correspond to each other, and reflecting curved surfaces of the third reflecting member and the fourth reflecting member correspond to each other.

8. The light source device as recited in claim 7, wherein the light source device is disposed in a road lamp, and the road lamp has a bottom seat and a light-transmissive housing, and the light source device is disposed on the bottom seat, and a light beam of each light source is reflected by each reflecting member and passes through the light-transmissive housing.
